(19) United States
(12) Patent Application Publication
(10) Pub. No.: US 2010/0307294 A1
(43) Pub. Date: Dec. 9, 2010

(54) MOUNTING DEVICE WITH AT LEAST ONE CAPTIVE MOUNTING SCREW

(76) Inventors: Bernard Schlegel, Rahden (DE); Sebastian Griepenstroh, Rahden (DE)

Correspondence Address: HAYES SOLOWAY P.C., 3450 E. SUNRISE DRIVE, SUITE 140, TUCSON, AZ, 85718, US

(21) Appl. No.: 12/782,476

(22) Filed: May 18, 2010

(30) Foreign Application Priority Data
Jun. 6, 2009 (DE) 20 2009 007 939.2

(51) Int. Cl. B25B 23/08

(52) U.S. Cl. 81/44

(57) ABSTRACT

In a mounting device with at least one mounting aperture that is situated in a flange and penetrated by a mounting screw, it is proposed to provide the flange with at least one slot on the edge of the mounting aperture. Furthermore, the diameter of the mounting aperture is smaller than the outside diameter of the screw thread of the mounting screw. Consequently, the elastic material properties of the flange are utilized in a particularly advantageous fashion because a certain force needs to be exerted in order to screw the mounting screw into the mounting aperture or out of the mounting aperture. This ensures that the mounting screw also cannot readily detach from the mounting aperture during long-lasting vibrations, i.e., it is captively held in the mounting aperture. This is particularly important if the mounting device comprises a grounding element that forms part of a connector and features the aforementioned flange, wherein said grounding element is designed for being snapped into an insulating member and for being transported to the assembly into a connector housing together with this insulating member.

### BACKGROUND OF THE INVENTION

1. Field of the Invention

The invention pertains to a mounting device that comprises a flange and at least one mounting screw with a screw thread, wherein the flange features at least one mounting aperture with a predetermined diameter, and wherein the mounting screw penetrates the mounting aperture.

Such a mounting device serves for holding mounting screws in the respective mounting aperture up to the final assembly. Such a mounting device comprises, in particular, a grounding element that forms part of a connector and features a flange of this type. Such a grounding element is designed for being snapped into an insulating member and for being transported to the assembly into a connector housing together with the insulating member. In this case, it is desirable to hold the at least one mounting screw in the mounting aperture of the flange in a captive fashion such that it is not lost during the transport.

2. Description of the Related Art

In the state of the art, for example, according to publication DE 103 10 164, it is known to captively hold a mounting screw on a cable lug. In this case, the mounting screw features a threadless holding section that is situated adjacent to the underside of a screw head and penetrates a mounting aperture of the cable lug, as well as a threaded section that borders on the holding section.

It is known, for example, from publication DE 299 01 497 U1 to prevent a screw from unscrewing, e.g., by applying a soft plastic layer in the threaded region of the screw. If this screw is installed repeatedly, however, at least part of this layer shears off such that the captivity function is not always ensured.

It is furthermore known from publication DE 299 01 497 U1 to inhibit the motion in the threaded region of the mounting flange due to the fact that this mounting flange does not feature a fully tapped thread. The inserted mounting screw does not take over the cutting function of a screw tap for the remaining threaded section until the installation. However, this requires screws with a corresponding material hardness.

Publication DE 299 01 497 U1 also proposes to arrange an impression adjacent to the threaded bore of the mounting flange such that the diameter of the threaded bore is constricted.

It was unfortunately determined that these known devices, in which a mounting screw is screwed into an internal thread of a mounting aperture, do not always fulfill the desired purpose because the mounting screws can detach from the respective mounting apertures due to vibrations during the transport.

### SUMMARY OF THE INVENTION

The invention therefore is based on the objective of disclosing a mounting device of the initially cited type that can be manufactured with low expenditures and ensures that a mounting screw also cannot detach from a mounting aperture, particularly from the mounting aperture of a grounding element that forms part of the mounting device, during long-lasting vibrations.

This objective is attained in that the flange features at least one slot on the mounting aperture, wherein the slot is designed for being elastically widened when the screw thread is screwed into the mounting aperture, and in that the screw thread has an outside diameter that is larger than the diameter of the mounting aperture.

The invention proposes a device that is suitable for ensuring that a certain force needs to be respectively exerted during the removal of a mounting screw from a mounting aperture due to a reversible deformation of the slot and therefore of the flange, wherein said force is defined, among other things, by the shape of the slot and the elastic material properties of the flange. Consequently, the mounting screws are prevented from detaching from their respective mounting apertures by themselves, namely even if they are subjected to vibrations for any period of time.

The elastic properties of the material of the flange therefore are utilized in a particularly advantageous fashion due to the presence of the slot.

One advantage attained with the invention can be seen in that the mounting screws are not lost during the transport.

The surface of the mounting screw and/or the mounting aperture is not damaged during the installation.

Due to the elastic deformation of the slot, the mounting screw can, if so required, also be unscrewed again without irreversibly altering or damaging the mounting screw or the flange, particularly in the region of the mounting aperture.

Accordingly, the motion is also inhibited in about the same fashion during additional installation and removal processes.

In one embodiment, the mounting screw features a threadless shaft section, as well as an adjacent threaded section with the screw thread, The threadless shaft section is designed for penetrating the mounting aperture and has a diameter that is smaller than the outside diameter of the screw thread. In another embodiment, the diameter of the shaft section is smaller than the diameter of the mounting aperture.

In one embodiment, the mounting aperture features an internal thread. In this case, the outside diameter of the internal thread is smaller than the outside diameter of the screw thread and/or the inside diameter of the internal thread is smaller than the inside diameter of the screw thread, whereby the internal thread is suitable for allowing the mounting screw to be screwed in and the slot to simultaneously widen elastically by exerting a corresponding force.

In another embodiment, the mounting screw is replaced with a mounting pin. This mounting pin can be distinguished from the mounting screw in that it does not feature a thread on a widened section. In this case, the mounting aperture also does not feature a thread. The diameter of the widened section of the mounting pin is larger than the diameter of the mounting aperture in this embodiment.

### BRIEF DESCRIPTION OF THE DRAWINGS

One exemplary embodiment of the invention is illustrated in the drawings and described in greater detail below. In these drawings:

FIG. 1 shows a grounding element with a flange, a mounting aperture and a slot.

FIG. 2 shows a mounting screw, and

FIG. 3 shows a mounting pin.

### DESCRIPTION OF THE PREFERRED EMBODIMENTS

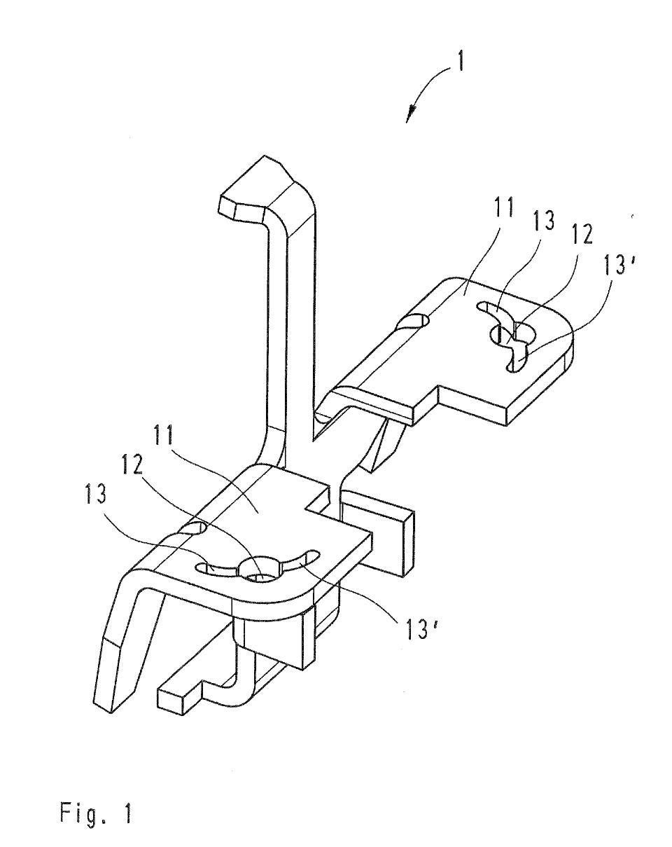

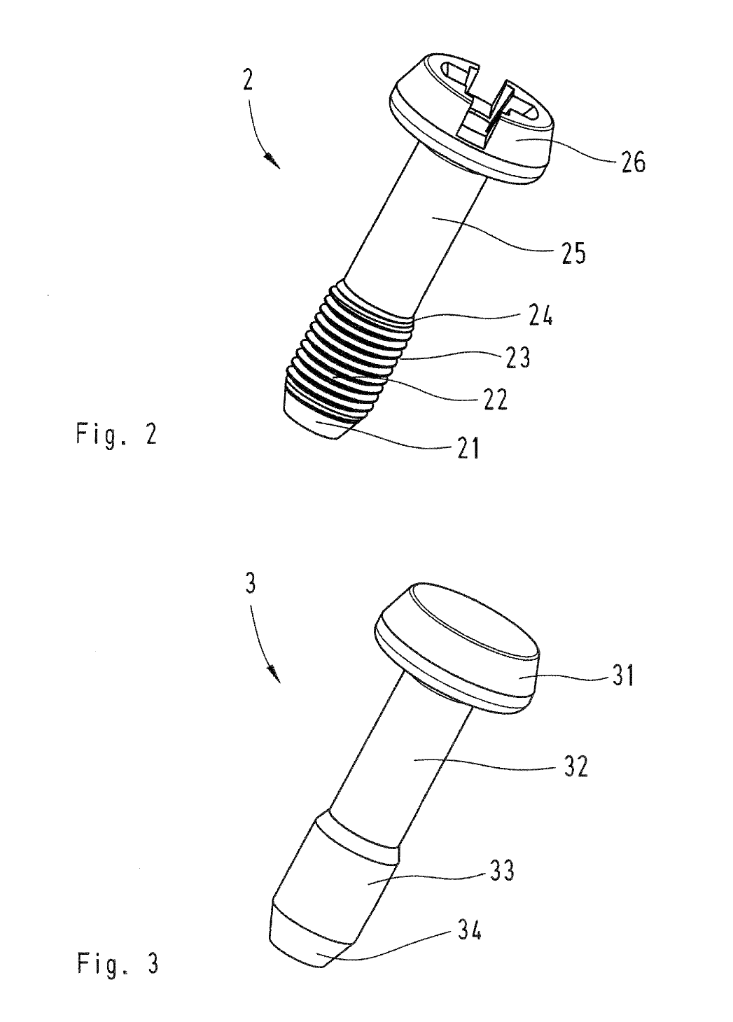

FIG. 1 shows a grounding element (1) of a connector. This grounding element (1) forms a mounting device together with the mounting screw (2) illustrated in FIG. 2. The grounding element (1) is designed for being snapped into an insulating member that also forms part of the connector, but is not illustrated in the drawings, and for being transported to the assembly into an also not-shown connector housing together with this insulating member. The grounding element (1) features two flanges (11) that are respectively provided with a mounting aperture (12), as well as two slots (13, 13′) that are arranged in the radial direction on the edge of the mounting aperture (12) and extend in the shape of a circular arc.

The mounting screw (2) illustrated in FIG. 2 features a trapezoidal point (21), a threaded section (22) with a thread (23), a thread runout (24), a shaft section (25) and a screw head (26).

The trapezoidal point (21) of the mounting screw (2) serves for simplifying the insertion of the mounting screw (2) into the mounting aperture (12) of the grounding element (1). The outside diameter of the thread (23) of the mounting screw (2) is larger than the diameter of the mounting aperture (12). The slots (13, 13′) serve for utilizing the elastic properties of the material of the flange (11) in a particularly advantageous fashion and therefore for only allowing the mounting screw (2) to be installed, particularly to be screwed in, if a predetermined force is exerted. Since the material of the flange (11) is only stressed in the elastic range during this process, a comparable force also needs to be exerted in order to unscrew the mounting screw (2). Consequently, the mounting screw (2) cannot detach due to vibrations only.

The invention also proposes another variation, in which the mounting screw (2) is replaced with a mounting pin (3) according to FIG. 3, wherein the mounting pin (3) features a pin head (31), a threadless pin shaft section (32) situated adjacent to the pin head (31) and a threadless widened section (33) that is situated adjacent to the pin shaft section (32) and features a trapezoidal pin point (34).

In this case, the flange features at least one mounting aperture (12) with a predetermined diameter. The mounting pin (3) penetrates this mounting aperture (12).

In this variation, the flange (11) also features at least one slot (13, 13′) on the edge of its mounting aperture (12), wherein the slot (13, 13′) is designed for being elastically widened when the mounting pin (3) is inserted into the mounting aperture (12). In this case, the widened section (33) of the pin has a diameter that is larger than the diameter of the mounting aperture (12).

The pin shaft section (32) has a radius that is smaller than the diameter of the mounting aperture (12) in this case.

What is claimed is:

1. A mounting device comprising a flange (11) and at least one mounting screw (2) with a screw thread (23), wherein the flange features at least one mounting aperture (12) with a predetermined diameter, and wherein the mounting screw (2) penetrates the mounting aperture (12), wherein the flange (11) features at least one slot (13, 13′) on the mounting aperture (12), wherein the slot (13, 13′) is designed for being elastically widened when the screw thread (23) of the mounting screw (2) is screwed into the mounting aperture (12), and in that the screw thread (23) has an outside diameter that is larger than the diameter of the mounting aperture (12).

2. The mounting device according to claim 1, wherein the mounting aperture (12) features an internal thread that is designed for allowing the screw thread (23) of the mounting screw (2) to be screwed in and the slot (13, 13′) to simultaneously widen elastically by exerting a corresponding force.

3. The mounting device according to claim 1, wherein the mounting screw features a screw head (26), a threadless shaft section (25) that is situated adjacent to the screw head (26) and designed for penetrating the mounting aperture (12), as well as a threaded section (22) that is situated adjacent to the shaft section (25) and provided with a screw thread (23).

4. The mounting device according to claim 3, wherein the threadless shaft section (25) has a diameter that is smaller than the outside diameter of the screw thread (23).
